(19) United States
(12) Patent Application Publication
(10) Pub. No.: US 2004/0060327 A1
(43) Pub. Date: Apr. 1, 2004

(54) Method for treating an optical fiber preform with deuterium

(76) Inventors: George E Berkey, Pine City, NY (US); Dana C Bookbinder, Corning, NY (US); Richard M Fiacco, Corning, NY (US); Jeffrey T Kohli, Brookfield, MA (US); Dale R Powers, Painted Post, NY (US)

Correspondence Address: CORNING INCORPORATED, SP-TI-3-1, CORNING, NY, 14831

(21) Appl. No.: 10/663,475

(22) Filed: Sep. 15, 2003

Related U.S. Application Data
(60) Provisional application No. 60/415,295, filed on Sep. 30, 2002.

(51) Int. Cl. C03B 37/018

(52) U.S. Cl. 65/422; 65/426; 65/424

(57) ABSTRACT

A method of forming an optical fiber preform that includes providing a consolidated glass preform, depositing a layer of silica soot onto the consolidated glass preform to form a composite preform having a consolidated glass portion and a silica soot portion, and exposing the composite preform to an atmosphere containing a concentration of a deuterium compound for a time and at a temperature sufficient to cause the deuterium compound to penetrate the consolidated glass portion without pervading the entire glass portion. Preferably, the deuterium compound penetrates the glass portion to a desired depth.

### FIELD OF THE INVENTION

The present invention relates to optical waveguides, and, more particularly, to methods for treating optical fiber preforms with deuterium.

### BACKGROUND OF THE INVENTION

Various methods of drying or dehydrating optical fiber preforms are known. Various known methods exist for treating optical fiber preforms, and/or optical fiber drawn therefrom, with deuterium.

A portion of a preform, such as a portion of corresponding to the core of a fiber drawn from the preform, may be doped with one or more compounds to achieve refractive index tuning.

### SUMMARY OF THE INVENTION

A method of forming an optical fiber preform is disclosed herein. The method comprises providing a consolidated glass preform precursor body having an outer surface, depositing a layer of silica soot onto the outer surface of the consolidated glass preform precursor body to form a composite preform comprised of a consolidated glass portion and a silica soot portion, and in a deuterium-exposing step, exposing the composite preform to an atmosphere containing a concentration of a deuterium compound for a time and at a temperature sufficient to cause the deuterium compound to penetrate the consolidated glass portion without pervading the entire glass portion.

The composite preform is exposed to a deuterium compound containing atmosphere preferably at a temperature less than the consolidation temperature of the silica soot portion of the composite preform. Concentrations of less than 100% deuterium containing compound are effectively utilized. In preferred embodiments, the composite preform is exposed to a deuterium compound containing atmosphere at less than 1300 C., and more preferably less than 1225 C. Preferably, exposure to the deuterium compound containing atmosphere occurs for less than about 1 hour with concentrations of less than 100% deuterium containing compound. Preferably, the deuterium containing compound is D₂ or D₂O or mixtures thereof, more preferably D2. In one preferred embodiment, the composite preform is exposed to an atmosphere containing 5% or less D₂ at less than 1225 C. for less than about 1 hour.

The depositing step may further comprise causing a hydrogen compound to penetrate the consolidated glass preform precursor body. Preferably, at least a portion of the hydrogen compound in the consolidated glass preform precursor body is exchanged with at least a portion of the deuterium compound.

Preferably, the method further comprises, after the depositing step, exposing the composite preform to a chlorine-compound-containing atmosphere. In preferred embodiments, the chlorine-compound-containing atmosphere comprises an inert gas.

In preferred embodiments, the composite preform is exposed to a chlorine-compound-containing atmosphere prior to the deuterium-exposing step.

In preferred embodiments, the composite preform is exposed to a purge atmosphere comprising an inert gas prior to the deuterium-exposing step.

Preferably, the composite preform is exposed to a chlorine-compound-containing atmosphere, and then the composite preform is exposed to a purge atmosphere comprising an inert gas, prior to the deuterium-exposing step.

Preferably, the composite preform is exposed to a purge atmosphere comprising an inert gas after the deuterium-exposing step.

In preferred embodiments, the composite preform is exposed to a chlorine-compound-containing atmosphere after the deuterium-exposing step.

Preferably, after the deuterium-exposing step, the composite preform is exposed to a purge atmosphere comprising an inert gas, and then the composite preform is exposed to a chlorine-compound-containing atmosphere.

The method may further comprise consolidating the silica soot portion to form a second consolidated glass preform precursor body comprised of the glass portion and a second glass portion formed from the silica soot portion. The depositing step and the deuterium-exposing step are then preferably repeated to obtain an other composite preform which is exposed to a deuterium atmosphere. In preferred embodiments, the second consolidated glass preform precursor body is heated and drawn to a reduced diameter prior to depositing silica soot thereon.

In preferred embodiments of the method disclosed herein, the deuterium compound penetrates the glass portion to a desired depth.

In preferred embodiments, the consolidated glass preform precursor body is generally cylindrical about a centerline axis, wherein at least a portion of the consolidated glass preform precursor body has a radial thickness RC1 measured from the centerline axis, and wherein less than 0.1 ppm of any deuterium compound is present at radii less than about 0.25 RC1.

Preferably, less than 0.1 ppm deuterium compound is formed by the reaction of deuterium with the consolidated glass portion at radii less than about one-fourth the radius of the consolidated glass preform precursor body.

In some preferred embodiments, less than 0.1 ppm of the deuterium compound is present at radii less than about 0.5 RC1. In other preferred embodiments, less than 0.1 ppm of the deuterium compound is present at radii less than about 0.75 RC1. In still preferred embodiments, less than 0.01 ppm of the deuterium compound is present at radii less than about 0.25 RC1.

In another aspect, an optical fiber preform is made in accordance with the method disclosed herein.

In yet another aspect, an optical fiber is formed by heating and drawing an optical fiber preform made in accordance with the method disclosed herein. In preferred embodiments, the optical fiber comprises a central region and an annular region surrounding the central region, wherein the annular region comprises deuterium-containing compound and the central region has substantially no deuterium-containing compound. Preferably no detectable deuterium-containing compound is present in the central region.

Objects of the present invention will be appreciated by those of ordinary skill in the art from a reading of the figures and the detailed description of the preferred embodiments which follow, such description being merely illustrative of the present invention.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic cross-sectional representation of a consolidated glass optical fiber preform having a layer of silica-based soot applied to its surface, as disclosed herein;

FIG. 2 is a schematic cross-sectional representation of a composite optical fiber preform comprising a glass portion and a soot portion resulting from the silica soot deposition onto the consolidated glass optical fiber preform illustrated in FIG. 1;

FIG. 3 is a schematic cross-sectional representation of the composite optical fiber preform of FIG. 2 which was treated with deuterium and disposed in a furnace, as disclosed herein;

FIG. 4 is a schematic cross-sectional representation of the composite optical fiber preform of FIG. 3 disposed in a furnace and after the soot portion was consolidated into a second glass portion as disclosed herein;

FIG. 5 shows OH (in ppm) plotted versus radial position in a comparative consolidated optical fiber preform which had no exposure to a deuterium-containing compound;

FIG. 6 shows OH (in ppm) and OD (in ppm) plotted versus radial position in a consolidated optical fiber preform similar to that of FIG. 5 but treated with a deuterium-containing compound as disclosed herein;

FIG. 7 is a schematic cross-sectional representation of a glass optical fiber preform, formed from the composite optical fiber preform of FIG. 4, wherein a silica-based soot layer is being applied thereto, as disclosed herein;

FIG. 8 is a schematic cross-sectional representation of a composite optical fiber preform having two glass portions and a soot portion, after the soot deposition illustrated in FIG. 7, as disclosed herein;

FIG. 9 is a schematic cross-sectional representation of the composite optical fiber preform of FIG. 8 disposed in a furnace, as disclosed herein;

FIG. 10 is a schematic cross-sectional representation of a glass optical fiber preform disposed in a furnace and having three glass portions formed from consolidation of the soot layer of the composite optical fiber preform of FIG. 8, as disclosed herein;

FIG. 11 is a schematic cross-sectional representation of a glass optical fiber preform having five glass portions, as disclosed herein;

FIG. 12 is a graphical representation of the spectral attenuation of optical fiber drawn from optical fiber preforms that were subjected to various exposures to deuterium compounds, as disclosed herein; and

FIG. 13 is a graphical representation of the spectral attenuation of optical fibers drawn from optical fiber preforms that were exposed to a deuterium compound containing atmosphere for various exposure times.

### DETAILED DESCRIPTION OF THE INVENTION

The present invention now will be described more fully hereinafter with reference to the accompanying drawings in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. The drawings are not to scale.

Methods and apparatus as disclosed herein are used to provide reduced levels of hydroxyl ions or OH ions in an optical waveguide preform, such as an optical fiber preform.

FIG. 1 schematically illustrates a cross-section of a glass preform precursor body 1 comprised of consolidated silica. The glass preform precursor body 1 has an outer radius of RC1. Preferably the glass preform precursor body 1 has a generally cylindrical shape wherein FIG. 1 represents a transverse cross-sectional view thereof. The silica may be doped or undoped. In one preferred embodiment, the glass preform precursor body 1 consists of pure silica. Preferably, the glass preform precursor body 1 is solid as shown in FIG. 1, and has an outer surface 12, preferably elongated. The glass preform precursor body 1 preferably has a low water content, i.e. a low hydroxyl, or low OH ion, content. Preferably, the glass precursor body 1 has an average OH concentration of less than 200 ppb, more preferably less than 100 ppb, still more preferably less than 50 ppb, yet still more preferably less than 1 ppb. Furthermore, the glass precursor body 1 preferably has a low deuterium content. Optionally, the glass preform precursor body may be exposed to deuterium compound containing gaseous atmosphere at a temperature and for a time sufficient to introduce deuterium compounds into the body. For example, the body may be pre-treated with D₂ or D₂O in accordance with International Patent Application WO01/47822. However, the body is preferably not pre-treated with deuterium compounds, and even more preferably not treated with D₂O. Preferably, the glass precursor body 10 has a deuterium concentration of less than 200 ppb, more preferably less than 100 ppb, still more preferably less than 50 ppb, yet still more preferably less than 1 ppb.

As illustrated in FIG. 1, silica soot is deposited on the outer surface 12. Preferably, the silica soot is generated by the flame of a burner 16, wherein the reaction products 20 of the flame are directed at, near or onto the glass preform precursor body 1. Preferably, the reaction products 20 comprise silica soot. Preferably, the silica soot comprises soot particles less than about 20 microns, more preferably less than about 12 microns, even more preferably less than about 1 micron. The silica soot preferably comprises undoped silicon compounds and/or doped silicon compounds. Even more preferably, the silica soot comprises undoped silicon oxides and/or doped silicon oxides. The reaction products 20 in the soot stream directed toward the glass preform precursor body 1 typically contain hydrogen compounds such as H₂O, H₂, and HCl. We have found that the deposition of silica soot containing hydrogen compounds upon the surface 12 of the glass preform precursor body 1 can cause sufficient penetration of the hydrogen compounds through the surface 12 of the glass preform precursor body 1 and into the consolidated glass making up the glass preform precursor body 1 to form hydroxyl species, which cause an increase in the attenuation of light signals passing through optical fiber drawn therefrom, particularly at wavelengths at or near the so-called water peak at about 1383 nm and at other OH overtone wavelengths.

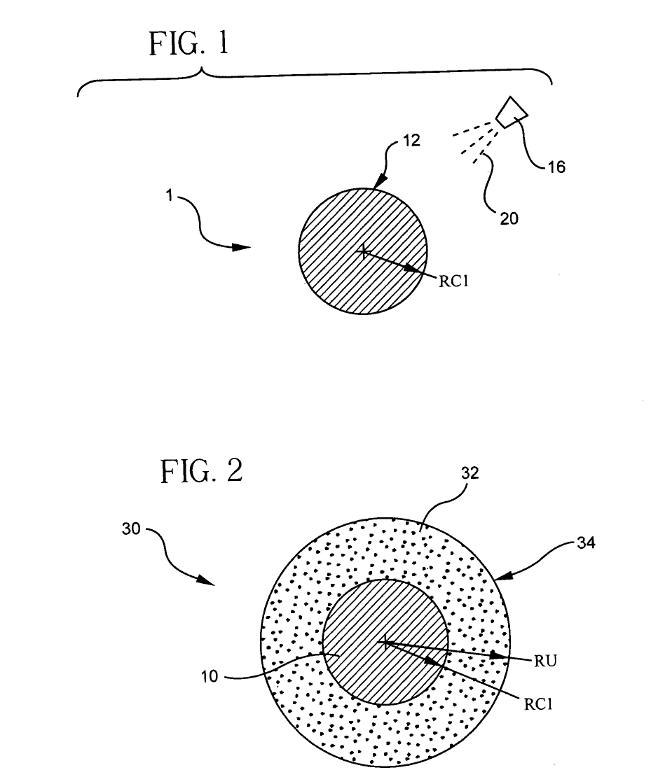

As schematically illustrated in FIG. 2, a composite optical fiber preform 30 results after an appropriate amount, or desired thickness, of soot is deposited on the glass preform precursor body 1 to form a soot layer 32, shown in FIG. 2 as having an outer surface 34 with an outer radius RU, which also forms the outer surface of the composite optical fiber preform 30. Thus, the composite optical fiber preform 30 is comprised of a glass portion 10, formed from the glass preform precursor body 1, and a soot portion 32, formed from the soot layer deposited on the glass preform precursor body 1.

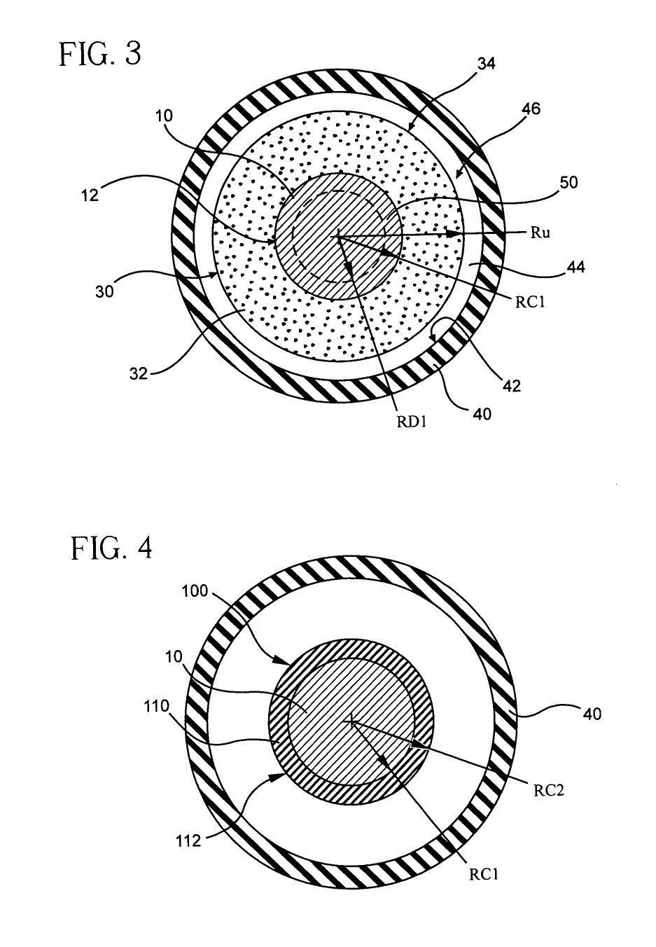

The composite optical fiber preform 30 is then preferably dried, or dehydrated, to help remove hydrogen compounds such as water and/or OH ions from the soot portion 32. Preferably, the composite optical fiber preform 30 is heated and exposed to an atmosphere having a dehydrating compound. Most preferably, at least the soot portion 32 of the composite optical fiber preform 30 is exposed to this dehydration atmosphere. As schematically illustrated in FIG. 3, in one preferred embodiment the composite optical fiber preform 30 is placed inside a furnace or oven 40 whose inner surface 42 forms a chamber 44 capable of receiving a preform. The chamber 44 and preferably the annular space 46 between the inner surface 42 of the furnace 40 and the outer surface 34 of the composite optical fiber preform 30 can thus be supplied with one or more gases to which the composite optical fiber preform 30 can be exposed. For example, a gaseous drying compound of a desired concentration, or within a desired range in concentration, and/or one or more inert gases of a desired concentration, or within a desired range of concentrations, can be supplied to the chamber 44 and the annular space 46. Most preferably, the glass portion 10 forms the centermost part of the composite optical fiber preform 30 and the soot portion 32 surrounds and is adjacent the outer periphery 12 of the glass portion 10.

Preferably, the dehydration atmosphere comprises a chlorine-containing compound. In a preferred embodiment, the dehydration atmosphere comprises a chlorine-containing compound and one or more inert gases. The chlorine-containing compound may be one or more of Cl₂, CCl₂, SOCl₂, SiCl₄, GeCl₄, or POCl₃. Other chlorine containing compounds may also be used. Preferably, the inert gas comprises helium, argon, or nitrogen, or combinations thereof. The chlorine-containing compound may be selected from the group consisting of Cl₂, CCl₂, SOCl₂, SiCl₄, GeCl₄, or POCl₃, or combinations thereof

Preferably, the step of exposing the composite optical fiber preform 30 to the dehydration atmosphere comprises heating the soot portion 32 to a dehydration temperature in the range of temperatures between 700° C. and the consolidation temperature of the soot portion 32. More preferably, the exposing step is carried out in a dehydration temperature range of about 700° C. to less than the consolidation temperature of the soot layer 32. Even more preferably, the dehydration temperature is in the range of about 800° C. to about 1300° C., and still more preferably between about 850° C. and about 1250° C. In one preferred embodiment, the dehydration temperature is between about 890° C. and about 1225° C. In preferred embodiments, the consolidation temperature is less than about 1500° C.

Without wishing or needing to be bound by theory, applicants believe that exposure of the composite optical fiber preform 30 to the dehydration atmosphere has little to no effect on the hydrogen compounds lodged within the glass portion 10 of the composite optical fiber preform 30 for periods of time considered practical in a manufacturing environment. Thus, drying or dehydration of the soot portion 32 is apparently insufficient to remove the hydrogen compounds within the glass portion 10 of the composite optical fiber preform 30, and the potential would therefore remain for increased attenuation due to the presence of the hydrogen compounds in an optical fiber eventually drawn therefrom.

After drying, the soot layer 32 is then exposed to an exchange atmosphere comprising a deuterium-containing compound. Preferably, the atmosphere exposed to the soot layer 32 is purged prior to exposure to the deuterium-containing compound. Preferably, the purge atmosphere is an inert gas atmosphere. The inert gas atmosphere preferably comprises helium, argon, or nitrogen, or combinations thereof.

The exchange atmosphere is a gaseous atmosphere preferably comprising D2, D2O, or combinations thereof. The deuterium-containing compound or compounds generally readily diffuse through the soot portion 32 of the composite optical fiber preform 30 and enter the glass portion 10 thereof. Preferably, the bulk density of the soot portion 32 is less than 0.9 g/cc, more preferably less than 0.8 g/cc, and still more preferably less than 0.7 g/cc. The deuterium-containing compound exchanges with the hydrogen-containing compound within the composite optical fiber preform 30 and decreases the amount of the hydrogen compound in the composite optical fiber preform. In particular, the deuterium-containing compound exchanges with the hydrogen-containing compound in the glass portion 10 of the composite optical fiber preform 30. In general, we have found that D₂ tends to diffuse into the glass portion 10 faster than D₂O.

We have found that uncontrolled exposure to a deuterium-containing compound can result in overdosing the glass portion 10 of the composite optical fiber preform 30 with deuterium-containing compound to such an extent that the attenuation of light signals passing through optical fiber drawn therefrom is undesirably or unacceptably increased, particularly at wavelengths at or near OD overtone wavelengths.

Preferably, the composite optical fiber preform 30 is exposed to an exchange atmosphere comprising deuterium-containing compound for a time and at a temperature sufficient to promote exchange of the hydrogen compound introduced into the glass portion 10 via the soot deposition process used to add the soot layer 32 to the glass portion 10, and more preferably for a time short enough and at a temperature sufficiently low enough to prevent deuterium compound from penetrating deep into the center of the glass portion 10. Thus, the deuterium is preferably prevented from penetrating into the part of the glass portion 10 of the composite optical fiber preform 30 corresponding to the location in an optical fiber drawn therefrom which carries a relatively higher intensity of a light signal passing therethrough as compared to the intensity of the light signal at greater radial distances. Generally, a higher light signal intensity occurs nearer the axial centerline of an optical fiber while lower light signal intensity occurs at radii further away from the axial centerline. As schematically illustrated in FIG. 3, the region of deuterium exchange in the glass portion 10 of the composite optical fiber preform 30, taken on a transverse plane perpendicular to the axial centerline, is thus preferably an annular deuterated region 50 which does not reach the axial centerline (r=0). Preferably, the annular deuterated region 50 has an inner radius RD1 and an outer radius that coincides with the outer radius RC1 of the glass portion 10 of the composite optical fiber preform 30. Preferably, the OD concentration in the glass portion 10 for radii less than RD1 is less than about 0.1 ppm, and most preferably 0. Preferably, the ratio of the inner radius RD1 divided by the outer radius of the glass portion 10, RC1, is greater than 0.25, more preferably greater than 0.5, and even more preferably greater than 0.75.

Preferably exposure to the exchange atmosphere is terminated before any deuterium-compound reaches the centerline of the composite optical fiber preform 30. More preferably, exposure to the exchange atmosphere is terminated prior to any deuterium compound being introduced beyond a desired depth (or beyond a desired thickness) into the composite preform.

Preferably, the composite optical fiber preform 30 is exposed to the exchange atmosphere such that greater than 50% of the OH compound in the glass portion is exchanged with OD compound, as measured, for example, on a weight or volume basis, or as reflected in a reduction in the peak OH concentration. More preferably, greater than 70% of the OH compound is exchanged with OD compound in the glass portion 10. In preferred embodiments, less than 100% of the OH compound is exchanged with OD compound in the glass portion 10.

The exchange atmosphere may comprise up to 100% deuterium-containing compound, although lower concentrations are also effective and help to reduce flammability concerns. In a preferred embodiment, the exchange atmosphere comprises less than or equal to about 5% concentration by volume of deuterium-containing compound mixed with an inert gas, wherein, preferably, the inert gas is argon or helium or nitrogen or a combination thereof. In another preferred embodiment, the exchange atmosphere comprises less than or equal to about 4% concentration by volume of deuterium-containing compound mixed with an inert gas, wherein, preferably, the inert gas is argon, nitrogen, or helium or a combination thereof. Preferably, the deuterium-containing compound is D₂.

Preferably, the exchange step comprises heating the composite optical fiber preform 30 to an exchange temperature in the range of about 600° C. to less than the consolidation temperature of the soot layer 32. Even more preferably, the exchange temperature is in the range of about 800° C. to about 1300° C., and still more preferably between about 850° C. and about 1250° C. In one preferred embodiment, the exchange temperature is between about 890° C. and about 1225° C. In another preferred embodiment, the exchange temperature is between about 1200° C. and about 1250° C. In yet another preferred embodiment, the exchange temperature is within 100° C. of the drying temperature, so as to minimize furnace heater cycling, temperature fluctuations, and/or time-temperature lags in the optical preform treatment process as the composite optical fiber preform 30 is exposed to one or more atmospheres corresponding to drying, purge, and/or exchange. In preferred embodiments, the consolidation temperature is less than about 1500° C.

Preferably, the exposure to the deuterium atmosphere during the exchange step occurs for greater than about 30 seconds, more preferably greater than about 1 minute. In one preferred embodiment, deuterium exposure lasts for greater than about 10 minutes.

In some preferred embodiments, hydrogen compound residual with a lowered concentration within the glass portion is tolerable, particularly if total or near-total exchange of hydrogen compound by deuterium compound would require an inward radial advancement of the deuterium compound front (i.e. a reduction in the radius RD1) to a depth sufficient to cause the deuterium compound to appear in the optical core of an optical fiber drawn therefrom, especially to the extent that unacceptable levels of attenuation in the optical fiber are induced at one or more wavelengths by the presence of the deuterium.

After exposure to the exchange atmosphere, the soot portion 32 is then dehydrated or dried, preferably by exposing the soot portion 32 to a dehydration atmosphere as described above in the above dehydration step. Preferably, the atmosphere exposed to the soot layer 32 is purged prior to this dehydration step. Preferably, the purge atmosphere is an inert gas atmosphere. The inert gas atmosphere preferably comprises helium, argon, or nitrogen, or combinations thereof.

Preferably, the drying and exchange steps are all performed in the same furnace 40, i.e. the composite optical fiber preform 30 is exposed to the various dehydration and exchange atmospheres, as well as any purge atmospheres, while the composite optical fiber preform 30 is disposed in one furnace.

After the soot portion 32 has been dehydrated, the soot portion 32 is then consolidated wherein the soot is turned into glass. In one preferred embodiment, consolidation occurs in the same furnace where the dehydration and exchange steps are performed.

FIG. 4 shows a consolidated glass optical fiber preform 100 formed from the composite optical fiber preform 30 of FIGS. 2 and 3. The soot portion 32 of the composite optical fiber preform 30 decreases in volume upon consolidation to form an added glass layer or outer glass portion 110 on the initial glass portion 10, wherein the thickness of the added glass layer 110 is small in comparison to the thickness of the soot layer 32. The outer surface 112 of the added glass layer 110 forms the outer surface of the glass optical fiber preform 100, and extends to radius RC2.

Thus, the soot portion 32 of the composite optical fiber preform 30 is consolidated and the composite optical fiber preform 30 is transformed into a glass optical fiber preform 100.

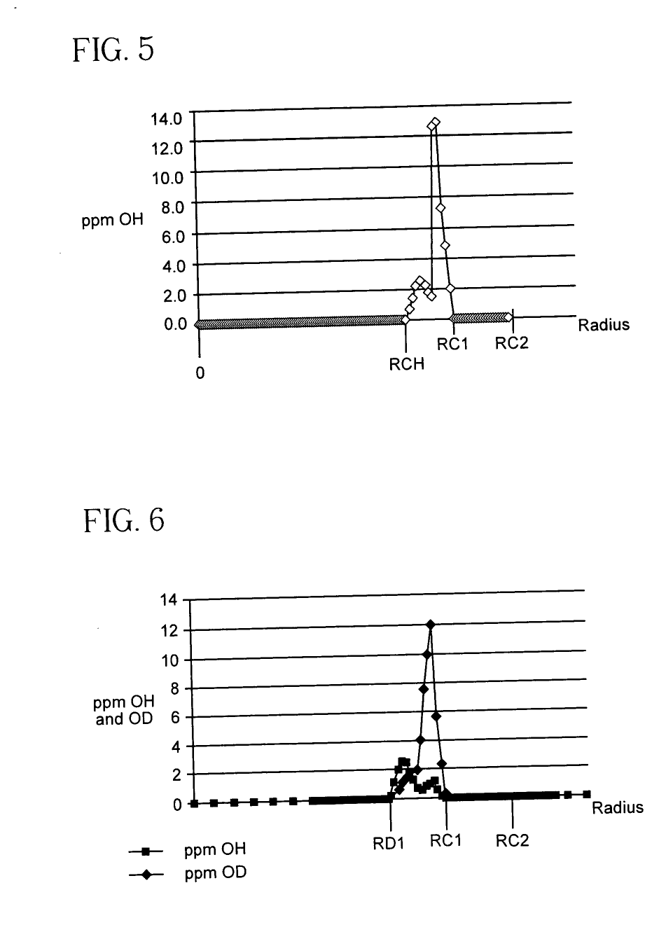

FIG. 5 shows OH (in ppm) plotted versus radial position in a consolidated optical fiber preform similar to that shown in FIG. 4 and which had no exposure to a deuterium-containing compound as disclosed herein. The glass portion extends from the centerline (r=0) to a radius, RC1, and the soot portion which was deposited on the outer surface of the glass portion and then consolidated extends from radius, RC1, to an outer radius, RC2. The presence of hydrogen compound (OH) was detected from a hydrogen compound inner radius RCH (where RCH here was about 0.8 RC1) to RC1. The peak OH of about 12 ppm was found at a radius of around 0.95 RC1.

FIG. 6 shows OH (in ppm) and OD (in ppm) plotted versus radial position in a consolidated optical fiber preform similar to that of FIG. 5 but treated with a deuterium-containing compound as disclosed herein. The presence of hydrogen compound (OH) was still detected from a radius of 0.8 RC1 to RC1, however the OH peak was reduced from about 12 ppm (in FIG. 5) to less than 3 ppm (in FIG. 6) for corresponding regions (i.e. at radii from around 0.8 RC1 to RC1). Furthermore, the presence of OD at radii less than a radius RD1, the inner radius of deuterium compound (here equal to about 0.7 RC1), was not detectable in the composite optical fiber preform of FIG. 6, being below measurement sensitivity at less than 0.1 ppm (by weight). Thus, the inward advance of the deuterium front was halted before the deuterium reached the proximity of the axial centerline (r=0) of the composite optical fiber preform 30. In this example, RD1 was approximately equal to the hydrogen compound inner radius, here RCH.

In some preferred embodiments, the glass optical fiber preform 100 is heated and drawn into optical fiber. In other preferred embodiments, the glass optical fiber preform 100 serves as second glass preform precursor body (i.e. as a target substrate) for additional soot deposition, as described above. The glass optical fiber preform 100 may be heated and pulled or drawn in order to reduce the diameter thereof one or more times before a soot deposition step. The above various steps of dehydration, exchange, and/or purge, as well as consolidation and/or reduction in diameter by heating and drawing, may then be repeated to add additional layers of glass to the optical fiber preform 100. The glass optical preform 100 may be heated and pulled or drawn in order to reduce the diameter thereof one or more times after one or more consolidation steps.

In preferred embodiments, during or after heating and pulling or drawing of the glass optical fiber preform 100 in order to reduce its diameter, the glass optical preform 100 is preferably severed lengthwise, that is, generally transverse to the axial centerline, so as to produce one or more glass optical fiber preforms of reduced diameter for further processing into optical fiber. Further processing could include, for example, additional soot deposition, and/or positioning within a silica-based tube, and/or additional reductions in diameter, and/or other process steps prior to drawing into optical fiber.

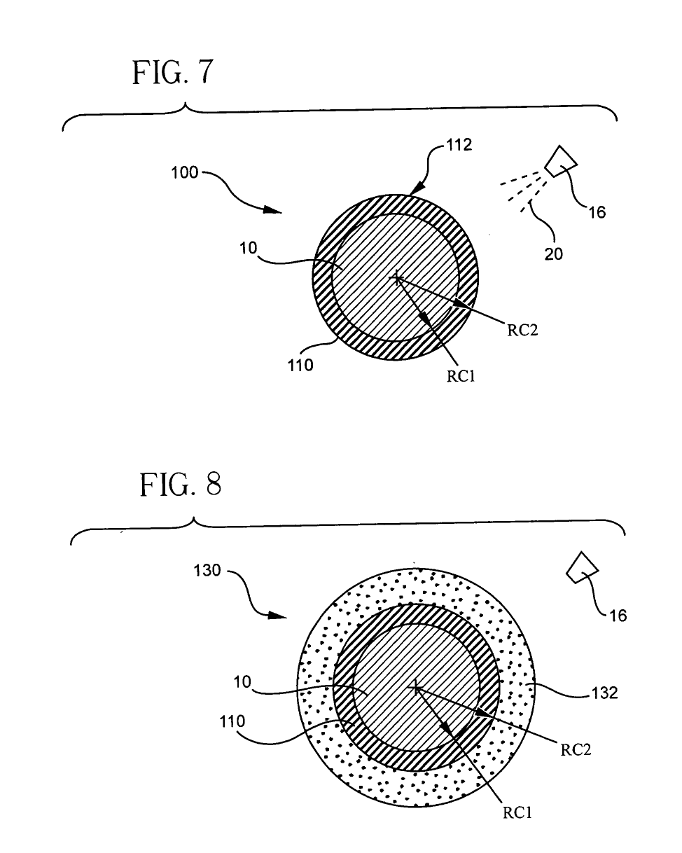

FIG. 7 schematically illustrates deposition of soot on the outer surface 112 of the glass optical fiber preform 100 of FIG. 4. In some preferred embodiments, the glass optical fiber preform 100 is heated and drawn to reduce its diameter prior to soot deposition. FIG. 8 shows a resulting soot layer or soot portion 132 surrounding the glass portions 110, 10 of the newly formed composite optical fiber preform 130, wherein a visual distinction between the two glass portions 10 and 110 in FIG. 7 has been retained here for illustration purposes. Thus, for example, the inner glass portion 10 may comprise one dopant compound (such as germanium) while the outer glass portion 110 may comprise another dopant compound (such as fluorine). It should be understood that the various glass portions in a preform formed as disclosed herein may contain the same dopants, different dopants, or no dopants, as desired, for example, to achieve a desired refractive index profile in an optical fiber drawn therefrom. Dopants may include, for example, germanium or germania, chlorine, fluorine, alkali metal oxides, alkaline earth oxides, transition metals, alumina, antimony oxide, boron oxide, erbium oxide, gallium oxide, indium oxide, lanthanum oxide, actinium oxide, tin oxide, lead oxide, phosphorus oxide, arsenic oxide, bismuth oxide, tellurium oxide, selenium oxide, titanium oxide, and/or mixtures thereof.

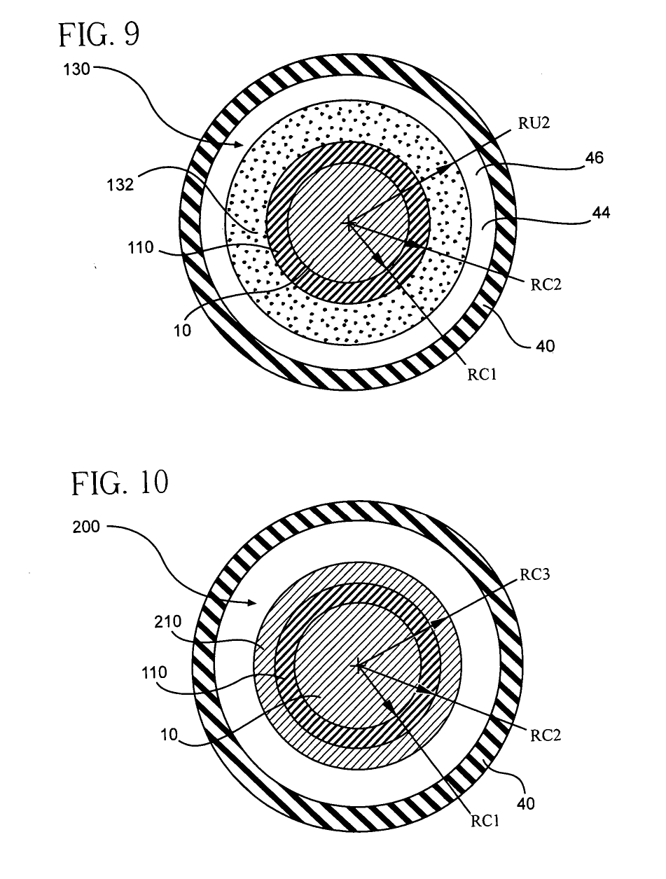

FIG. 9 schematically represents the composite optical fiber preform 130 of FIG. 8 disposed within a furnace 40 having an inner surface 42 that forms a chamber 44 including an annular space 46 around the outer surface of the composite optical fiber preform 130 formed by the outer surface of the soot layer 132 indicated by the radius RU2. The composite optical fiber preform 130 then preferably undergoes dehydration, followed by exchange, followed by dehydration, as described above.

FIG. 10 schematically represents the glass optical fiber preform 200 comprising three glass portions 10, 110, 210, the outermost glass portion 210 resulting from consolidation of the soot portion 132 of the composite optical fiber preform 130 of FIG. 9. The outer surface 212 of the glass optical fiber preform 200 extends to a radius RC3.

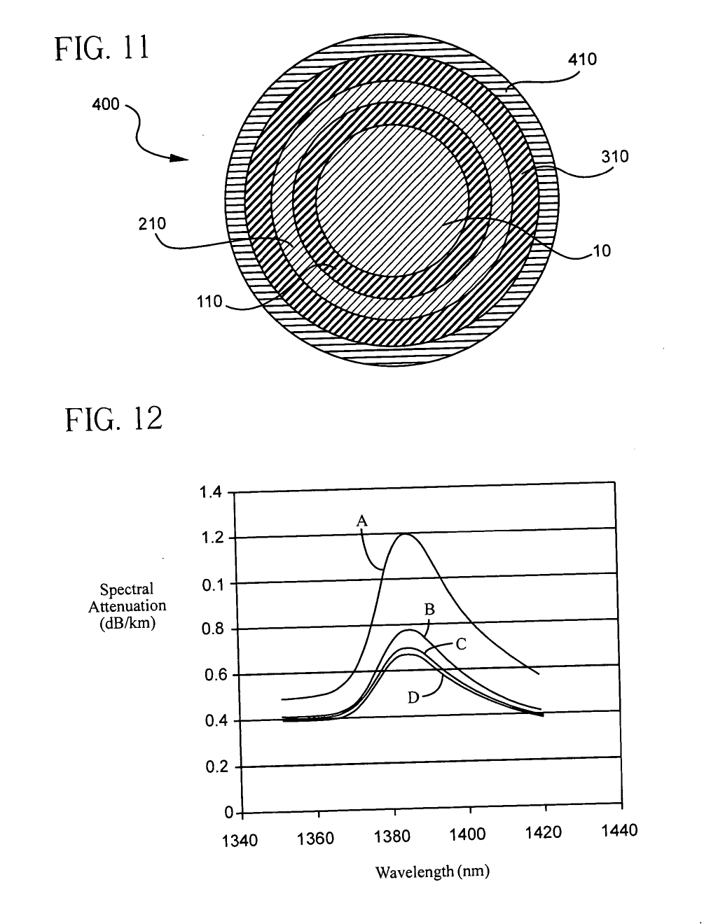

FIG. 11 schematically represents a glass optical fiber preform comprising five glass portions, 10, 110, 210, 310, and 410, such as would result from adding two more glass portions to the glass optical fiber preform of FIG. 10.

### EXAMPLE 1

### Comparative

A solid glass preform precursor body, or “cane”, was severed into several lengthwise pieces to form a plurality of glass preform precursor bodies. The cane was composed of a doped central region containing about 8 wt % GeO₂-92 wt % SiO₂. The central region had a diameter of about ⅓ of the outside diameter of the cane. The outer portion of the cane was essentially pure SiO₂. Silica soot was deposited on one piece of the glass preform precursor body to form a composite optical fiber preform. The composite optical fiber preform was exposed to an atmosphere of Cl₂ gas at 1225° C. for 60 minutes, followed by another exposure to an atmosphere of Cl₂ gas at 1225° C. for 60 minutes. The composite optical fiber preform was not exposed to any deuterium atmosphere. The soot layer of the composite optical fiber preform was then consolidated, and the resulting glass optical fiber preform was drawn into optical fiber. The spectral attenuation measured in the optical fiber at wavelengths from 1350 nm to 1420 nm appear as line A in FIG. 12.

### EXAMPLE 2

Silica soot was deposited on another lengthwise piece of the cane (or glass preform precursor body) of Example 1 to form another composite optical fiber preform. The composite optical fiber preform in this case was exposed to an atmosphere of Cl₂ gas at 1225° C. for 60 minutes, followed by exposure to a purge atmosphere of Ar gas between about 1000° C. and about 1225° C. for 15 minutes, followed by exposure to an exchange atmosphere of 3% D₂ gas and 97% Ar gas at 1100° C. for 15 minutes. The soot layer of the composite optical fiber preform was then consolidated, and the resulting glass optical fiber preform was drawn into optical fiber. The spectral attenuation measured in the optical fiber at wavelengths from 1350 nm to 1420 nm appear as line B in FIG. 12.

### EXAMPLE 3

Silica soot was deposited on yet another lengthwise piece of the cane (or glass preform precursor body) of Example 1 to form yet another composite optical fiber preform. The composite optical fiber preform in this case was exposed to an atmosphere of Cl₂ gas at 1225° C. for 60 minutes, followed by exposure to an exchange atmosphere of 3% D₂ gas and 97% Ar gas at 1100° C. for 15 minutes, followed by exposure to an atmosphere of Cl₂ gas at 1225° C. for 60 minutes. The soot layer of the composite optical fiber preform was then consolidated, and the resulting glass optical fiber preform was drawn into optical fiber. The spectral attenuation measured in the optical fiber at wavelengths from 1350 nm to 1420 nm appear as line C in FIG. 12.

### EXAMPLE 4

Silica soot was deposited on still another lengthwise piece of the cane (or glass preform precursor body) of Example 1 to form still another composite optical fiber preform. The composite optical fiber preform in this case was exposed to an atmosphere of Cl₂ gas at 1225° C. for 60 minutes, followed by exposure to a purge atmosphere of Ar gas between about 1000° C. and about 1225° C. for 15 minutes, followed by exposure to an exchange atmosphere of 3% D₂ gas and 97% Ar gas at 1100° C. for 15 minutes. The soot layer of the composite optical fiber preform was then consolidated, and the resulting glass optical fiber preform was drawn into optical fiber. The spectral attenuation measured in the optical fiber at wavelengths from 1350 nm to 1420 nm appear as line D in FIG. 12.

As seen in FIG. 12, treatment of the composite optical fiber preform by exposure to a deuterium atmosphere according to the three preferred embodiments of Examples 2, 3, and 4 above lowered the attenuation around the water peak wavelength of 1383 nm from about 1.2 dB/km to less than about 0.8 dB/km. Even more preferably, the spectral attenuation of the water (OH) peak wavelength of 1383 nm was lowered to less than about 0.7 dB/km.

We have surprisingly found that indiscriminate dosing or overdosing of an optical fiber preform or an optical fiber with a deuterium compound, can lead to increased spectral attenuation not only at known OD overtones but also at an overtone centered at about 1590 nm.

In order to illustrate the effect of deuterium compound overdosing, a solid glass preform precursor was made and severed into a plurality of lengthwise pieces, thereby forming a plurality of glass precursor preforms, or “canes”.

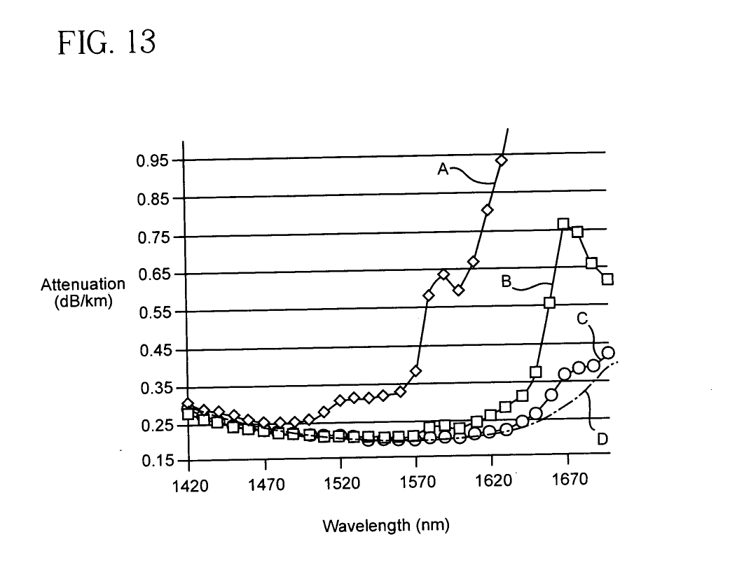

A first cane was exposed to a gaseous atmosphere of 5% by volume D₂ in helium at 1000° C. for 8 hours. The cane was overclad and drawn into a first optical fiber. The spectral attenuation of the first fiber is shown as line A in FIG. 13.

A second cane was exposed to a gaseous atmosphere of 5% by volume D₂ in helium at 1000° C. for 4 hours. The cane was overclad and drawn into a second optical fiber. The spectral attenuation of the second fiber is shown as line B in FIG. 13.

A third cane was exposed to a gaseous atmosphere of 5% by volume D₂ in helium at 1000° C. for 1 hour. The cane was overclad and drawn into a third optical fiber. The spectral attenuation of the third fiber is shown as line C in FIG. 13.

A fourth cane was not treated with deuterium compound as a control. The cane was overclad and drawn into a fourth optical fiber. The spectral attenuation of the fourth fiber is shown as line D in FIG. 13.

As illustrated by lines A and B of FIG. 13, an attenuation peak at about 1670 nm can form due to the presence of deuterium compounds in the optical fiber. With even greater exposure to deuterium compound, i.e. with a higher deuterium compound content in the optical fiber, additional attenuation peaks can form at about 1530 nm (to around 1550 nm) and at about 1590 nm. These OD overtones at 1530 nm and 1590 nm were not found by applicants in the literature. These attenuation peaks result from excessive treatment of a glass body with a deuterium compound.

In a preferred embodiment, an optical fiber drawn from an optical fiber preform made as disclosed herein exhibits attenuation at a wavelength of 1590 nm which is not more than 0.15 dB above its spectral attenuation at a wavelength of 1550 nm.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method of forming an optical fiber preform, the method comprising:
providing a consolidated glass preform precursor body having an outer surface;
depositing a layer of silica soot onto the outer surface of the consolidated glass preform precursor body to form a composite preform comprised of a consolidated glass portion and a silica soot portion; and
in a deuterium-exposing step, exposing the composite preform to an atmosphere containing a concentration of a deuterium compound for a time and at a temperature sufficient to cause the deuterium compound to penetrate the consolidated glass portion without pervading the entire glass portion.

2. The method of claim 1 wherein the depositing step further comprises causing a hydrogen compound to penetrate the consolidated glass preform precursor body.

3. The method of claim 2 wherein at least a portion of the hydrogen compound in the consolidated glass preform precursor body is exchanged with at least a portion of the deuterium compound.

4. The method of claim 1 further comprising, after the depositing step, exposing the composite preform to a chlorine-compound-containing atmosphere.

5. The method of claim 4 wherein the chlorine-compound-containing atmosphere comprises an inert gas.

6. The method of claim 4 wherein, the composite preform is exposed to a chlorine-compound-containing atmosphere prior to the deuterium-exposing step.

7. The method of claim 4 wherein the composite preform is exposed to a purge atmosphere comprising an inert gas prior to the deuterium-exposing step.

8. The method of claim 4 wherein the composite preform is exposed to a chlorine-compound-containing atmosphere, and then the composite preform is exposed to a purge atmosphere comprising an inert gas, prior to the deuterium-exposing step.

9. The method of claim 4 wherein the composite preform is exposed to a purge atmosphere comprising an inert gas after the deuterium-exposing step.

10. The method of claim 4 wherein the composite preform is exposed to a chlorine-compound-containing atmosphere after the deuterium-exposing step.

11. The method of claim 4 wherein, after the deuterium-exposing step, the composite preform is exposed to a purge atmosphere comprising an inert gas, and then the composite preform is exposed to a chlorine-compound-containing atmosphere.

12. The method of claim 1 further comprising consolidating the silica soot portion to form a second consolidated glass preform precursor body comprised of the glass portion and a second glass portion formed from the silica soot portion.

13. The method of claim 12 further comprising repeating the depositing step and the deuterium-exposing step.

14. The method of claim 13 further comprising heating and drawing the second consolidated glass preform precursor body to a reduced diameter prior to depositing silica soot thereon.

15. The method of claim 1 wherein the deuterium compound penetrates the glass portion to a desired depth.

16. The method of claim 1 wherein the consolidated glass preform precursor body is generally cylindrical about a centerline axis, wherein at least a portion of the consolidated glass preform precursor body has a radial thickness RC1 measured from the centerline axis, and wherein less than 0.1 ppm of any deuterium compound is present at radii less than about 0.25 RC1.

17. The method of claim 1 wherein less than 0.1 ppm deuterium compound is formed by the reaction of deuterium with the consolidated glass portion at radii less than about one-fourth the radius of the consolidated glass preform precursor body.

18. The method of claim 16 wherein less than 0.1 ppm of the deuterium compound is present at radii less than about 0.5 RC1.

19. The method of claim 16 wherein less than 0.1 ppm of the deuterium compound is present at radii less than about 0.75 RC1.

20. An optical fiber preform made in accordance with the method of claim 1.
